(19) United States
(12) Patent Application Publication
(10) Pub. No.: US 2009/0133677 A1
(43) Pub. Date: May 28, 2009

(54) Squish flow coupling in an ic engine withhigh energy coil per plug inductive ignition with improved pencil type coils

(75) Inventor: Michael A.V. Ward, Lexington, MA (US)

Correspondence Address: BURNS & LEVINSON, LLP, 125 SUMMER STREET, BOSTON, MA, 02110, US

(73) Assignee: Combustion Electromagnetics, Inc., Arlington, MA (US)

(21) Appl. No.: 11/662,165

(22) PCT Filed: Sep. 9, 2005
(86) PCT No.: PCT/US05/32307

§ 371 Date: May 29, 2008

Related U.S. Application Data
(60) Provisional application No. 60/608,249, filed on Sep. 9, 2004.
(60) Provisional application No. 60/612,925, filed on Sep. 25, 2004.

(51) Int. Cl. F02P 15/08; F02B 23/08

(52) U.S. Cl. 123/594; 123/661

(57) ABSTRACT

An improved ignition-combustion system for internal combustion engines with preferably a 2-valve engine 17/18 with dual-ignition 14a,14b with squish-flow channels 12a, 12b, and cylindrical high energy density pencil coils with open ends including biasing magnets 42a to 42d, the spark being 300 to 450 ma peak secondary current Is, and the primary current being 20 to 25 amps Ip of 60 to 100 turns Np, or bifiler turns of 120 to 200 turns of wire, with turns ratio Ns/Np of 50 to 70, and coil switches being 600 volt IGBTs; and power convertor with energy storage capacitor storing many times the coil energy of 80 mJ to 160 mJ, of 20 to 60) volts power supply, the engine operating with a single ignition firing of 80 to 16 mJ, except when it is cold started or requires multi-firing for better performance, such as under lean burn or high EGR operation.

This application claims priority under USC 119(e) of provisional applications Ser. No. 60/608,249, filed Sep. 9, 2004, and Ser. No. 60/612,925, filed Sep. 29, 2004.

### FIELD OF THE INVENTION

This invention relates to inductive type ignition systems for spark ignition internal combustion (IC) engines, in particular to high energy ignition systems with high energy density coils operating at higher voltage and current, and with engines with high squish flow in the region of ignition.

### BACKGROUND OF THE INVENTION AND PRIOR ART

The invention relates, in part, to a 42 volt based coil-per-plug ignition system as is disclosed in my U.S. Pat. No. 6,142,130, referred to henceforth as '130, to simplify and improve its packaging and operation, including improving the energy density and efficiency of its ignition coils of the cylindrical pencil coil type, through the use of biasing magnets, also disclosed, in part, in my PCT patent application No. PCT/US03/12057, referred to henceforth as '057, and published as WO 2003/089784A3 on Oct. 30, 2003. The disclosures of '130 and '057, and other patents and patent applications cited below, are incorporated herein as though set out at length herein.

Attempts to increase the efficiency of the IC engine through ultra-lean, fast burn, high compression ratio, have had less success than hoped for, in part because of the inability to have complete combustion at the very lean mixtures, resulting in unburnt fuel and high hydrocarbon emissions. Some of the best results achieved in ultra-lean burn were: 1) by Michael May with his fast burn, lean burn, Fireball engine, reported in a 1979 SAE paper No. 790386, where he creates high squish flow directed via a narrow single channel leading from under the intake valve to a combustion chamber under the exhaust valve, and 2) by me, as disclosed in my U.S. Pat. Nos. 5,517,961 and 6,267,107 B1, referred to henceforth as '961 and '107, wherein is disclosed the coupling of squish flow with one or more ignition sparks, particularly in '107 where is disclosed a dual ignition, 2-valve engine, with dual, high squish lands and spark plugs located at each of the high squish flow regions to couple the flow to a special high energy spark to help spread it towards the center of the combustion chamber. The high energy sparks thus produced are disclosed, in part, in my U.S. patent '130, and in part, in my PCT patent application '057. The disclosures of my published patent application '057 and patents '961, '130 and '107, are incorporated herein by reference as though set out at length herein. Another prior art patent which discloses a method of improving engine efficiency through the use of channeled squish flow is U.S. Pat. No. 6,237,579, issued May 1, 2001, which discloses producing more than one such channel in the squish regions of an engine to improve the fuel-air mixing and turbulence.

### SUMMARY AND OBJECTS OF THE PRESENT INVENTION

The ignition-flow coupling method disclosed in my above referenced patent '107 can be improved pursuant to the present invention by the use of one or more essentially radially inwards disposed narrow channels or other flow direction means located at or near the squish land regions for directing the squish flow to the spark plug tip so that the flow moves in a more directed, organized, channeled way, versus directing flow in a diffused way at the edge of the squish zone, to improve the coupling of the flow to the spark to move and spread it with greater intensity and control than might otherwise take place without the use of the channeled flow. In the preferred embodiment where part or most of the combustion chamber is under the exhaust valve, the channels are disposed to move the squish induced flow though the spark gap and more towards the exhaust valve for improved combustion. Thus the spark gap is substantially immersed in the squish flow.

In accordance with the present invention, the packaging of the coil-per-plug ignition system referenced in '130 and '057, in particular for a four cylinder engine, which represent the majority of IC engines today, although four cylinder engines with dual spark plugs per cylinder would be another preferred application, and so would a six or eight cylinder engines, with dual spark plugs as in the Chrysler hemi V-8 engine, and in patent '107.

In a further simplification of the present invention to achieve a plug-and-play feature for a coil-per-plug ignition, the car distributor spark plug wires are replaced with a trigger and phasing harness for providing well defined ignition trigger firing signals for the ECU and one or more well defined phasing signals for determining the firing cylinder, useful for all engines, including older 6 and 8 cylinder engines to be retrofitted with coil-per-plug ignition.

For implementing a feature of the simplified plug-and-play feature of the present invention, higher energy density and higher efficiency pencil type inductive ignition coils of the ignition system disclosed in '130 are achieved by the use of biasing magnets to substantially raise the coil energy density and efficiency. Novel use of low cost biasing magnets and coil winding structure, including bi-filar primary winding with primary turns Np of 60 and 90 (120 to 180 turns of wire), allows for a short and efficient cylindrical coil with spark energy in the 100 mJ to 150 mj range and with secondary current of 300 ma to 450 ma, which is a small and light enough coil to be directly mounted on the spark plug even in conventional two-valve 2 to 8 cylinder engines.

The invention preferably provides a plastic bobbin on which the secondary wire is wound wherein the bobbin is of the preferred segmented type with slots for taking the wire from one bay to another made up of very narrow slots oriented at a small angle, e.g. 18°, relative to the flanges, instead of 90°, to provide a long breakdown path between flanges across the slots, especially at the high voltage end where the flanges may be thicker and where the slot ends preferably overlap for even a longer breakdown path.

The present invention uses a well defined mathematical and physical relationship, discovered and developed by the present inventor, between coil input and output parameters, including coil energy and other terms, to define a coils turns ratio Nt which provides the maximum desired peak coil output voltage Vs(max) for a given maximum peak primary voltage Vp(max), so that, in principle, a protection primary winding voltage clamping device may not be needed. As part of the definition of the complete ignition system, the value Cs(plug) of the spark plug capacitance is needed, which preferably ranges between 10 and 50 picoFarads (pF).

For the preferred embodiment of dual ignition, an improved form of pencil coil with two open ends is disclosed, wherein pairs of biasing magnets are used at each of the two open ends to substantially improve the coil energy density and delivered spark energy for improved squish flow coupling. Moreover, the lengths and weights of the coils are reduced from the current state-of-the-art coils, even for three times a higher energy, to make the coils more universally applicable and cost effective, especially in dual ignition applications, as is the preferred application disclosed herein. Moreover, given the high efficiency of the coils, which are preferably charged from a higher voltage Vc higher than the standard 12 volt battery, e.g. between 25 volts and 60 volts, and assuming the use of a blocking high voltage diode in the secondary winding of the coils, then the coils can be fired with several ignition pulses (with an overall high duty cycle of approximately 80%) during cold-start and idle to provide extended duration higher energy sparks to improve combustion stability.

Other features and objects of the invention will be apparent from the following detailed drawings of preferred embodiments of the invention taken in conjunction with the accompanying drawings, in which:

### BRIEF DESCRIPTION OF THE DRAWINGS

FIGS. 1a to 1c represent, in partial schematic, approximately to scale, top views of three preferred embodiments of a 2-valve, dual ignition, engine combustion chamber with channels placed in the high squish zones of the dual squish lands, which can be located in the cylinder head as shown here, or on the piston or on a separate plate held between the cylinder head and cylinder. FIG. 1d represents a side view of FIGS. 1a to 1c through a line joining the two spark plugs excluding the channels.

FIG. 2 is a an approximately to-scale, side-view drawing of a prior art high energy density, high current, low inductance pencil coil, disclosed in '130, and FIG. 2a is a partial end view drawing of the coil of FIG. 2, showing the inner and outer magnetic core.

FIG. 3 is an approximately to-scale, partial side-view drawing of a high energy density pencil coil embodiment with two open ends, one end of which includes two large essentially rectangular magnets, and FIG. 3a is a partial end view drawing of the coil of FIG. 3, at the end where the magnets are placed.

FIG. 4 is an approximately to-scale, partial side-view drawing of a preferred high energy density, high current, low inductance pencil coil, with two open ends, with magnets located at each open end.

FIG. 5 is an approximately two-times scale drawing of an end section such as shown in FIG. 3a wherein four, instead of two, essentially rectangular magnets are used.

FIG. 6a is a partial side-view drawing of the intersection between the inner magnetic core and two biasing magnets defining magnetic flux (Φ) and other parameters used in arriving at optimized design criteria for the pencil coils of FIGS. 3, 4 and 7, and FIG. 6b shows a two-dimensional, partial view of the center core and one magnet, used to obtain actual preferred dimensions of the magnets relative to the coil magnetic core.

FIG. 7 is an approximately to-scale, partial side-view drawing of a preferred form of high energy density, high current, low inductance pencil coil, with two open ends, with magnets located at each end.

FIG. 8 is a partial schematic view of an ignition distributor to be used in conjunction with a coil-per-plug replacement wherein the distributor spark plug wires are replaced with an electronic trigger and phasing harness for providing well-defined ignition trigger firing signal for the ECU and phasing signals for firing the ignition coils in the proper order.

FIG. 9 is an approximately twice-scale side view drawing of a segmented bobbin for a preferred E-core of a coil-per-plug ignition of my patent '130 of square core cross-section, showing a preferred form of thin slot cut in the flanges for passing the wire between bays.

FIG. 10 is a twice scale, side view detailed drawing of an example of a pencil coil that is preferred for the present application wherein a high energy spark of order 100 mJ can be provided to improve ignition flow coupling with the squish flow. FIG. 10a is and end view.

FIG. 11 is a partial block diagram and partial circuit diagram of one ignition coil of possible several coils for multi-cylinder engines for providing the high energy spark with the capability of extending the spark duration by multiple firing. FIGS. 11a and 11b are possible spark profiles of the extended duration spark for cold-start and idle conditions respectively.

FIG. 12 is an approximately to scale, top view drawing of a preferred embodiment of a compact, open E-type ignition coil with two magnets at the open ends, and using silicon iron laminations, the outer legs being larger stacks of thin strips of laminations separate from a center “T” leg smaller stack of laminations.

### DISCLOSURE OF PREFERRED EMBODIMENTS

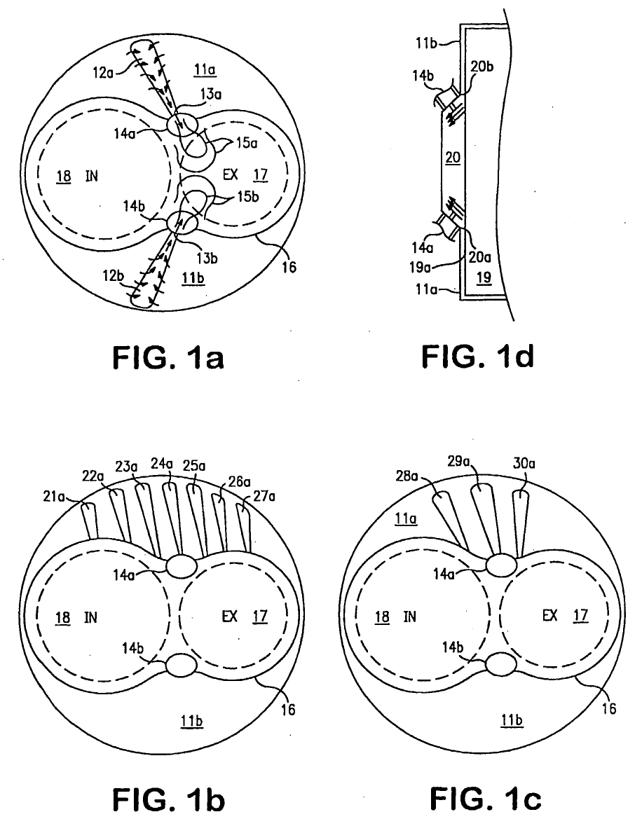

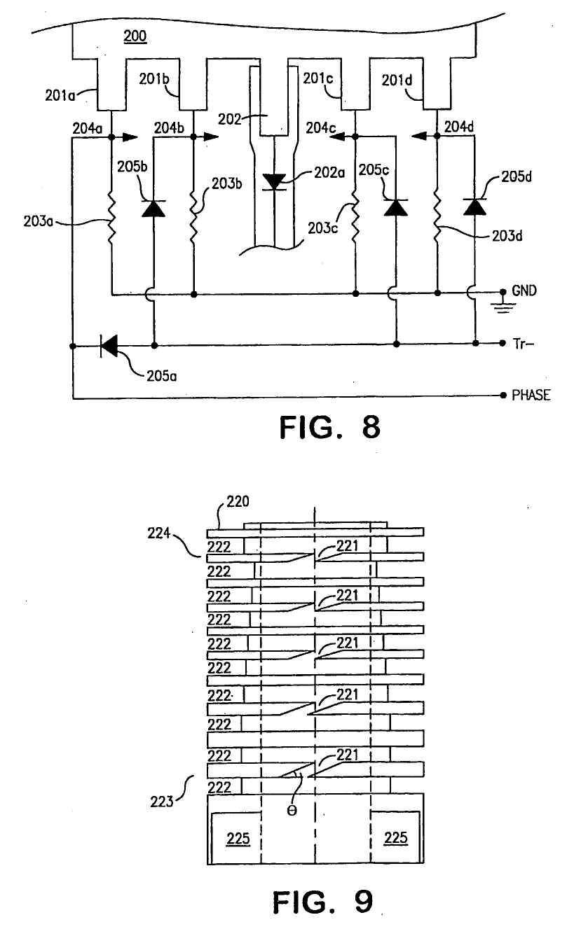

FIGS. 1a to 1c represent, in partial schematic form, approximately to scale, top views of three preferred embodiments of a 2-valve, dual ignition, engine combustion chamber with channels placed in the high squish zones 11a and 11b of the dual squish lands. In FIG. 1a is shown only one channel 12a and 12b per squish land 11a, 11b, with arrows indicating the air-flow when the piston is moving up and is near top center, wherein the air-flow moves sideways and inwards to fill each channel 12a and 12b, to then along the channel to flow and be squeezed out of the orifices 13a and 13b located adjacent to the spark gaps of the spark plugs 14a and 14b to direct the spark discharges and initial flame front 15a and 15b towards the center of the combustion chamber defined to be mainly within by the sideways “figure 8” boundary 16, but preferably more towards the exhaust valve 17 (indicated as “EX”) than the intake valve 18 (indicated as “IN”), since combustion is improved, i.e. is speeded up and is more complete, if it takes place initially under the hotter exhaust valve region than the cooler intake valve region.

As shown in the drawing, the channel is wider at the periphery of the combustion chamber and narrower at the squish land end defined by the contour 16 near the central regions where the spark plugs 14a and 14b are located. In this way, the flow at the orifice regions 13a and 13b will be more directed and intense to couple, i.e. interact with, the spark discharge and initial flame front 15a and 15b. Note that while dual ignition is preferred it is not essential, as disclosed in my U.S. patent '961 Preferably, at top center TC (piston at the top of its motion), the clearance between the piston top and the cylinder head in the squish land regions 11a and 11b should be as small as possible, e.g. 0.02″ to 0.05″ to help intensify both the diffuse squish flow along the more central region of the perimeter 16 and the directed squish flow at the orifices 13a and 13b.

FIGS. 1b and FIG. 1c are similar to FIG. 1a, with like numerals representing like parts with respect to FIG. 1a, except that in these figures multiple channels are disclosed. In FIG. 1b, seven channels 21a to 27a are shown, with mirror image, or other channels located on the bottom squish land 11b, which are not shown. As in FIG. 1a, the channels are preferably disposed to move the flame towards the combustion chamber center and more towards the exhaust valve. In FIG. 1c, three, more centrally located channels 28a to 30a are shown, with their orifices near the spark plug 14a and its gap.

FIG. 1d is a side view of FIGS. 1a to 1c through a line joining the spark plugs 14a and 14b. Like numerals represent like parts with respect to FIGS. 1a to 1c. The view shows the combustion chamber 20 with the piston at its top center position, wherein the piston 19 has a simple, flat surface 19a which serves to define the squish regions 20a and 20b, as well as to provide a flat surface which makes it more difficult for fuel to accumulate on.

In operation, as the piston moves up near TC, the channeled air-fuel mixture flow is directed through the spark gap and radially inwards, so that upon ignition, which occurs near the time of maximum squish induced flow, the very high energy, flow-coupling type of spark disclosed in my above referenced patents, is directed inwards and towards the hotter regions of the combustion chamber (exhaust valve region) and spreads to create a more distributed and higher energy spark discharge to substantially improve ignition and early flame propagation. Also, as disclosed in my patent '107, the turbulence is increased due to the colliding squish flows to further speed up the burn, where the turbulence can be further increased in this case by the channeled flows which have better penetrating capabilities, resulting in a faster and more complete burn of the preferred ultra-lean mixtures.

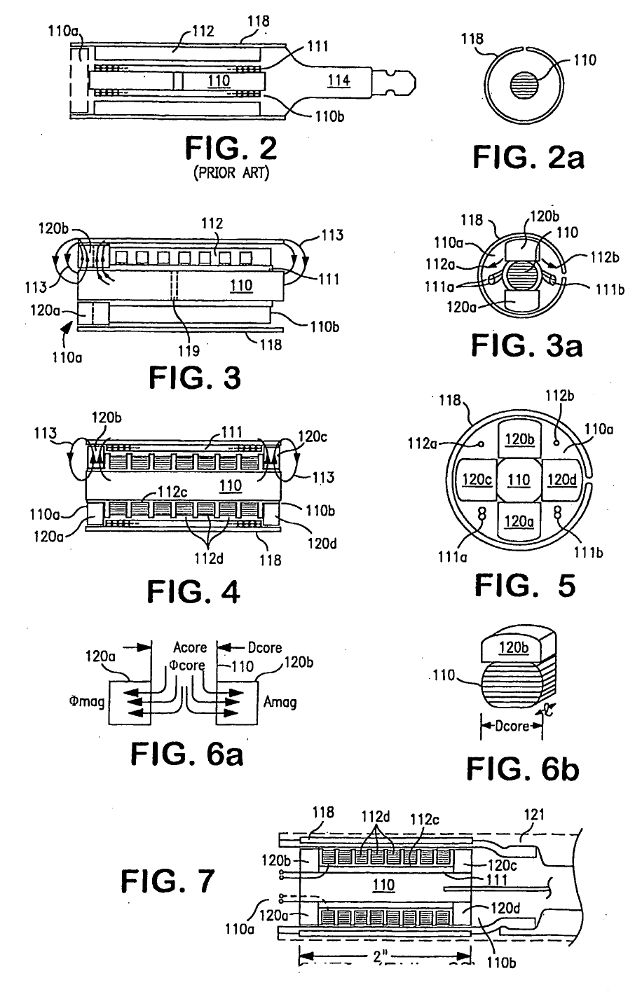

FIG. 2 is a an approximately to-scale, side-view drawing of a prior art high energy density, high current, low inductance pencil coil, disclosed in my patent '130. FIG. 2a is a partial end view drawing of the coil of FIG. 2, showing the inner and outer magnetic cores. In this preferred embodiment, with center magnetic core 110 is made up of thin silicon iron (SiFe) strips, of various widths, to comprise an approximate circular cross-section, as is indicated in FIG. 2a. The outer core is of thin, cylindrical magnetic core material as was disclosed in '130. The low voltage end 110a, and the high voltage end 110b, can both be open, or the one end 110a can have a cylindrical cap as indicated (of ferrite, powder iron, or other material) to simulate an E-type coil disclosed in '130. A pencil coil with both ends open, and with a small air-gap in the middle, was designed and built by Combustion Electromagnetics Inc. (CEI) under my direction, with a high voltage tower 114, and tested in the period 1996 to 1997 by CEI and Chrysler Corporation, and found to have a stored energy in excess of 100 mJ. In that design, flattened primary wire 111 was used, and a secondary winding 112 was wound on a segmented bobbin.

FIG. 3 is an approximately to-scale partial side-view drawing of an improved high energy density pencil coil embodiment based on the general design of FIG. 2, with both ends 110a and 110b open. FIG. 3a is an approximately to scale, partial end view of the low voltage end 110a. Like numerals represent like parts with respect to FIGS. 2 and 2a. In this improved design, two essentially rectangular, low-cost magnets 120a and 120b are placed between the inner magnetic core 110 and the outer core 118 (cylindrical sleeve) at the low voltage end 110a, sized to provide substantial countering magnetic flux bias to the magnetic cores. In the drawing are shown magnetic flux lines 113 due to one of the two magnets 120b at the one end, the main point to note is that approximately half of the magnetic flux lines are uncoupled and short circuit at the left open end air gap 110a, and approximately half the flux lines are coupled and move along the outer magnetic core 118 and across the high voltage open end air-gap 110b, since the two air gaps are approximately equal and represent approximately equal resistance, i.e. reluctance, to the magnetic flux lines that prefer to move in regions of high permeability μ.

Since the magnetic flux of rare earth magnets is approximately equal to 1.0 Tesla (assuming some inevitable leakage), or approximately half the peak flux density sustainable by high quality SiFe core material, then the magnet must have twice the area relative to the core area whose flux it is designed to fully oppose. But since half the flux is uncoupled, i.e. leaked out the uncoupled end as mentioned, then the magnet must have approximately four times the area relative to the core area it is designed to counter.

With a view to FIG. 3, half of the left side of the magnet 120b, defined by the broken center line, has leakage (uncoupled) flux lines, and half (right side) has coupled (useful) flux lines. In terms of the core area Acore; each of the two magnets must have four times the half core area (twice the total core area Acore) at right angles to the flux lines in the area facing the core, where the magnet area Amag in contact with the inner core 110 is shown to be flat (FIG. 3a), and the top magnet area is contoured with a circular arc to conform to the outer core cylindrical sleeve (which is preferred but not essential).

In this design, the primary winding 111 (with ends 111a and 111b) is shown located on the inside, made up of preferably a two layer bi-filar winding of 50 to 100 turns Np, and the secondary winding is located on the outside, with ends 112a and 112b (if a sense wire is used), in the preferred form of axially segmented windings, as shown, with typical turns ratio between 50 and 70 for a preferred 40 to 45 kV peak output voltage. A thin biasing magnet 119 may be placed at the center of the inner core, although this may excessively reduce the primary inductance Lp, which is between 0.2 and 2.0 milliHenry (mH), and preferably between 300 and 600 uH for the present high energy high current application of stored energy between 80 and 160 mJ, with 55 to 80 turns Np of bifilar wound primary wire, of typically 21 to 24 AWG (American Wire Gauge) for the shown size of approximately 2.5″ length and approximately 1.0″ diameter (excluding any high voltage tower 114 that may be required). Preferably the center core 110, FIG. 3a, has two flats, top and bottom, by limiting the width of the narrowest required laminations, which make convenient flat surfaces for mounting the two magnets 120a and 120b. For a pencil coil of outer diameter (OD) of approximately 1.0″, the center core maximum diameter is approximately 0.35″, for a core area Acore between 0.5 and 0.7 square centimeters (cm).

As used herein, the term “approximately” means within ±25% of the term it qualifies, and the term “about” means between 0.5 and 2 times the value it qualifies.

FIG. 4 is an approximately generally to-scale partial side-view drawing of an improved high energy density pencil coil based on the design of FIGS. 2 and 3, with both ends 110a and 110b open, the further improvement being that two pairs of magnets 120a, 120b, 120c, and 120d are located at each of the two open ends 110a and 110b, between the inner core 110 and outer core 118, with dimensions such as to apply an essentially fully countering magnetic bias to the magnetic cores. Like numerals represent like parts with respect to the earlier figures. In this preferred embodiment, the secondary winding made up of segmented bobbin 112c and wire 112d is preferably on the inside, with the inner core 110 preferably electrically floating, and the primary winding, made up of preferably two layer bi-filar winding, is on the outside, as shown. Flattened wire may be used in lieu of bifilar wire, i.e. two parallel wires, although the bifilar winding is preferred as it is generally lower cost and easier to wind.

For the same countering magnetic flux of the magnets, each magnet is half the size of the case of FIGS. 3 and 3a where two magnets were used on one end. Moreover, it has been found that using magnets on the two ends is more effective, i.e. results in higher coil energy, than using two magnets of twice the area Amag on one end, or using four magnets of the same size all on one end, as indicated in FIG. 5, which is an approximately two-times scale drawing of a low voltage end section 110a, such as shown in FIG. 3a, wherein four, instead of two, essentially rectangular magnets are used. In FIG. 5, like numerals represent like parts with respect to the earlier figures.

FIG. 6a is a partial side-view drawing of the intersection between the inner magnetic core 110 and two biasing magnets 120a and 120b, defining magnetic flux (Φ) and other parameters used in arriving at optimized design criteria for the pencil coils of FIGS. 3, 4 and 7. FIG. 6b shows a two-dimensional, partial view of the center core 110 and one magnet 120b, used to obtain actual preferred dimensions of the magnets relative to the coil magnetic core. Like numerals represent like parts with respect to the earlier figures.

With respect to FIGS. 6a, 6b, assuming two like magnets, and assuming no leakage, then φmag=½*φcore, which has to be corrected for the two coil open ends which reduce The coupled flux in half, so that φmag=φcore is the requirement for full countering of the magnets of the peak flux due to magnetic charging of the coil core. However, assuming a peak magnetic flux of 1 Tesla for the magnet, versus 2 Tesla for the coil core, then the area of the magnet Amag must follow the relationship, Amag=2*Acore for two magnets. For the preferred case of four magnets, two on each end, we obtain:

Amag≈Acore

i.e. the magnet area must equal approximately the core area for full magnetic countering or biasing of the coil magnetic core.

Recognizing that for the laminated structure with flats on two ends, the effective core area based on the diameter Dcore is less than the circular area, we can assume an effective core area Acore(eff) for convenience of calculation of 0.8 the circular area. It follows that:

Acore(eff)≈0.8*π*Dcore²/4

For the magnet area, we assume a rectangular cross-section of width equal to the core diameter and a length “l” (letter “ell”) as indicated in FIG. 6b. It follows that:

Amag≈Dcore*l

Equating the two as required, one obtains:

l≈0.2*π*Dcore

Assuming a core diameter Dcore of approximately 0.35″ (Acore≈0.5 cm²),

l≈0.22″

which defines a preferred embodiment of certain dimensions of a pencil coil.

FIG. 7 represents a preferred embodiment of a pencil coil of the above approximate dimensions, with an indicated approximate length of 2″ (two inches) from one magnet end to the other, and a preferred overall diameter of approximately 1.0″. The drawing is an approximately to-scale, partial side-view of the preferred high energy density, high current, low inductance pencil coil, of particularly compact size, with two open ends 110a and 110b with magnets 120a, 120b, 120c, and 120d located at each open end between the inner 110 and outer 118 core, as shown also in FIG. 4. An advantage of two open ends, versus one open end as in an open E-core, is an equivalent larger air gap where high magnetic energy can be stored, to make for a lighter weight coil, despite the use of approximately twice the magnet weights due to the approximately 50% versus closer to 100% magnetic coupling. This results in a short and lightweight coil, which can have a heavy-walled rubber boot 121 placed over part or all of the coil, the coil and boot comprising a semi-rigid structure that can be directly mounted onto a free standing spark plug, as typically found in two valve engines. Like numerals represent like parts with respect to the earlier figures.

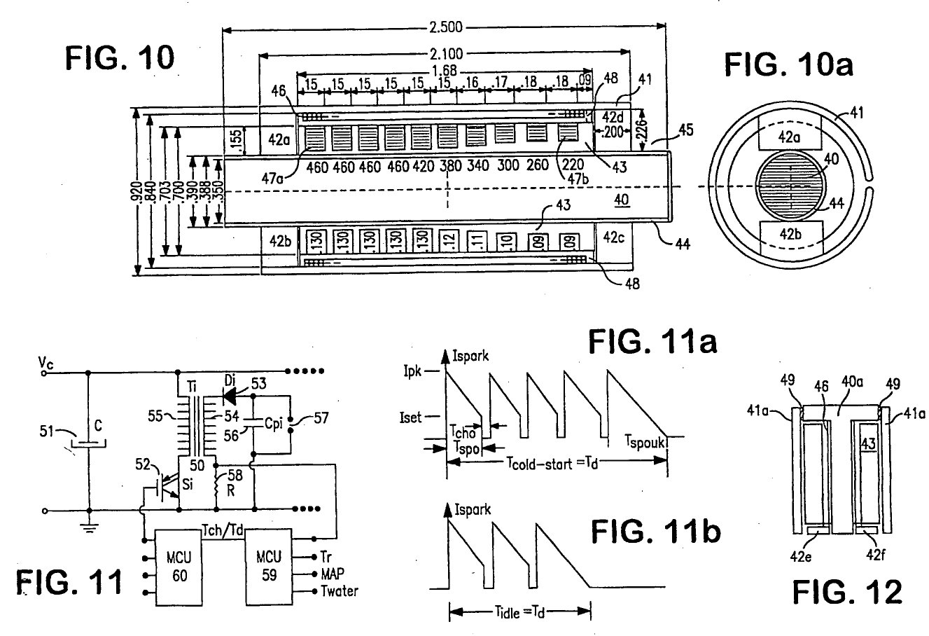

In this design, the secondary winding is shown with preferably eight winding bays, wherein the last flanges are thicker as disclosed with reference to my other patents and patent applications '130 and '057, and shown also in FIG. 10 for a coil with square cross-section (the number of bays shown there being 10 for a higher peak voltage of 44 to 48 kV). The primary turns 111 are shown on the inside, and they can equally well be on the outside, as in FIG. 4. In this design, preferably approximately 60 turns Np of bifilar wire are wound using 22 to 23 AWG, selected to fill the available winding length lp of approximately 1.6″ in this case, with turns ratio Nt of approximately 60, determined according to a formula to be disclosed, for a preferred peak output voltage of 42 kV, with preferably approximately 3,600 turns of 38 AWG for the wire of the secondary winding, i.e. between 37 and 39 AWG.

For lower peak secondary current, e.g. 350 ma to 400 ma, approximately 70 turns Np of bifilar wire of 24 to 26 AWG, of approximately 4,000 secondary turns Ns. Lp will be equal to approximately 600 uH, and primary current Ip will be approximately 23 amps.

The primary peak charge current for this design, which is expected to have a primary inductance Lp of between 350 and 450 uH, is between 24 and 28 amps for a stored energy Ep between 100 and 160 mJ, depending on the more exact dimensions, wherein the lower energy is for an overall smaller size coil.

Taking a typical design with Lp=400 uH, Ip=26 A, Np=60, Acore=0.5 cm², one has for the total magnetic flux swing Btot, stored energy Ep, and peak secondary current Is:

Btot=(4*26)/(0.5*60)=3.45 Tesla

Ep=½*0.4*(26²)=135 mJ

Is=Ip/Nt=26/60≈430 ma

where the magnets can provide a magnetic flux bias of −1.7 Tesla and the charging current a peak flux of 1.75 Tesla.

FIG. 8 is a partial schematic view of an ignition distributor cap 200, shown in this case for a 4-cylinder engine, to be used in conjunction with a coil-per-plug retrofit ignition, wherein the distributor cap spark plug wires which are mounted on the cap terminals 201a to 201d are replaced with an electronic trigger and phasing harness of wires for providing well-defined ignition trigger firing signals for the ECU and for providing one or more phasing signals for firing the ignition coils in the proper order. The center coil tower 202 may include a high voltage diode 202a to block the positive going voltage during coil charging, given that there are no spark gaps on the outputs of the terminals 201a to 201d to hold-off the positive voltage (although there is a small rotor gap).

In this design, the cap terminals-are terminated in resistors 203a to 203d to provide a sequential negative voltage Vtr− at the terminals 204a to 204d (indicated by arrows) when the ignition is fired and the engine is running. The voltages Vtr− can be summed by diodes 205a to 205d to provide a well defined trigger Tr− at each ignition firing which can then be used as a trigger input for the ECU. The phase signal, designated “Phase” output, can be connected directly to the ignitor board to indicate the cylinder being fired, which is especially useful for 8 cylinder engines where the strategy of simultaneously firing of the coils on cranldng and sensing with the extra coil sense wire, may not be practical.

This design can be implemented in several ways, including having a distributor cap replacement wherein the components are mounted or built-into the cap, which in turn provides two or more wires, the trigger wire Tr− and one or more phase wires. Alternatively, a harness can be provided that plugs into the top of the distributor cap in a defined way (after the spark plug wires have been removed). The “harness” can be a small board which can be mounted adjacent to the distributor cap with short wires extending from the board to cap, or a board that actually plugs in on top of the distributor cap.

FIG. 9 is an approximately twice-scale side view drawing of a segmented bobbin 220 for a preferred open E-core of a coil-per-plug ignition of my patent '130 of square core cross-section, showing a preferred form of thin slot 221 cut into the flanges for passing the secondary winding wire 112 between the bays 222. In this preferred embodiment, wherein the bobbin can be equally well of round cross-section for the preferred pencil coils, the slots 221 for are made up of very narrow slots oriented at a small angle θ, e.g. about equal to 18°, relative to the flanges length direction, instead of 90°, to provide a long breakdown path between flanges across the slots, especially at the high voltage end 223 (versus the low voltage end 224) where the flanges may be thicker and where the slots may be significantly thinner than the flange thickness, so that the ends of the flanges (pointed sections) defining the slot can overlap by a significant amount for even a longer breakdown path. This bobbin design contains openings 225 at the high voltage open end 223 for two magnets, as disclosed in my patent application '057. For the preferred pencil coil of FIG. 7, such openings 225 would be included at both ends, although the openings may be structurally different.

With regard to defining the optimum turns ratio Nt, there is disclosed an improved way of doing this, which is of particular use for high energy coils as disclosed herein, noting that the turns ratio Nt for a secondary maximum allowed peak voltage Vs is normally taken to follow the relationship:

Nt=Vsm/Vclamp

where Vclamp is the voltage at which the high end Vp of the primary coil winding 111 of the ignition coil is clamped (to not exceed so as to not damage the switch Swi, which in this case is preferably 600 volt IGBT switches).

In the present case of the high energy, high efficiency coils used preferably in this ignition and disclosed in '130 and '057, a voltage doubling effect exists which is similar to that discovered by me and disclosed in my U.S. Pat. No. 4,677,960 ('960). In this case, it is reflected in a higher than expected maximum peak output voltage Vsm given by:

Vsm=[2*Nt/(1+Es/Ep)]*Vclamp

where Es/Ep is less than one, to give a reduced design turns ratio of:

Nt=[Vsn/Vclamp]*[1+Es/Ep]/2

where Es=the energy stored in the coil secondary capacitance, given by ½*Cs*Vsm², and

Ep=Epo−Esw−Elpe−Eclamp,

where Epo is the energy stored in the coil, Esw is the energy dissipated in the switch Swi on switch opening, Elpe is the coil leakage energy, and Eclamp is the energy dissipated in the clamp after switch opening.

For example, assuming Vsm is 40 kV, Vp is 500 volts, then based on the conventional view, the required turns ratio Nt is given by:

Nt=40,000/500=80

From the equation disclosed, assuming Lp is 320 uH, Ic is 32 amps, so that Epo equals 160 mJ, and assming Elpe, Eswitch, and Eclamp are each equal to 10 mJ, and:

Es=½*Cs*Vsm²

where we assume Cs=50 picofarads (pF), 20 pF from the coil and 30 pF from the plug,

Es=1/2*5*4² mJ=40 mJ

Nt=80*[1+40/(160−30)]/2=40*[1.31]=52 turns ratio

which is much less than the 80 based on the conventional approach.

It can be shown that for a 48 KV output voltage and a clamp voltage of 600 volts, based on otherwise same parameters, the turns ratio is given by:

Nt=[48,000/600]*[1+58/(130)]/2=80*[0.72]=58 turns ratio

which is again much less than the 80 based on the conventional approach.

FIG. 10 is approximately a twice scale, side view detailed drawing of an example of a pencil coil that is preferred for the present application wherein a high energy spark of order 100 mJ can be provided to improve ignition flow coupling with the squish flow. The coil comprises central magnetic core 40 made up preferably of thin strips of different width of silicon iron (SiFe) to make up an essentially round core, with an outer magnetic core cylindrical thin sleeve 41, with the two essentially cylindrical cores defining two open ends where two pairs of biasing magnets 42a to 42d are located. In this preferred embodiment, the secondary bobbin 43, shown with 10 bays, is on the inside, separated from the core 40 by the insulating sleeve 44 which also serves to allow the core 40 to move within the sleeve 44 to accommodate the different material expansion coefficients, and the core 40 is preferably electrically floating. The bobbin is designed to have larger clearances to the core 40 and the primary winding 46 at the high voltage end 45, as is known to those versed in the art. The shaded portions in the bays, e.g. 47a representing the first bay at the low voltage end, represent the secondary wire winding, with a possible preferred number of turns indicated directly below the bay, i.e. ranging from 460 at the left most bay 47a down to 220 at the right most, highest voltage bay 47b, for a total turns Ns shown of 3,760 of preferably 38 American Wire Gauge (AWG) heavy insulated magnet wire. The dimensions shown above the bays, starting with 0.15″ at the left to 0.18″ at the second most right, including the flange, represent the bay width, where the bay width may be a constant of, say 0.11″, with the flange widths ranging from 0.04″ to 0.07″. Above the secondary bobbin 43 is the primary winding bobbin 48, which for the preferred dimensions show, has approximately 70 turns (Np) of bifilar winding of 24 AWG wire, to give a secondary turns Ns to primary turns Np ratio Nt of approximately 54. In the drawing, preferred dimensions are shown for a possible design which can store 150 mJ or more of magnetic energy, in large part due to the biasing magnets 42a to 42d located at the ends between the two concentric cores 40 and 41, shown with side width dimensions of 0.2″ and end width dimensions approximately equal to the center core diameter (shown as 0.35″). The preferred depth of the bays are given in the dimensions at the bottom, which range from 0.13 at the low voltage end to 0.09 at the high voltage end 45.

FIG. 11 is a partial block diagram and partial circuit diagram of one ignition coil Ti (50) of possible several coils for multi-cylinder engines for providing the high energy spark with the capability of extending the spark duration by multiple firing. FIGS. 11a and 11b are possible spark profiles of the extended duration spark for cold-start and idle conditions respectively.

The basic circuit shown, and its operation, has been disclosed in my patent '130, wherein the voltage charging the coils Ti is at a higher voltage Vc, preferably at three times 12 volt battery voltage, i.e. 42 volts, which charges a capacitor 51 of capacitance C to an energy many times the energy delivered on one charging of the coil, typically between 100 and 200 milli-Joules (mJ), so that multiple charging of the coil is possible on one ignition firing.

Control switch 52 (Si for coil Ti) is preferably a 600 volt IGBT, and blocking diode 53 (Di for coil Ti) in the secondary coil winding 54 is a high voltage diode (several kilovolts rating) to block current flow during coil (primary winding 55) charging, the remaining coil circuit comprising preferably a capacitive plug at the output with a capacitor 56 of value Cpl of 20 to 50 picoFarads (pF), and spark gap 57. Shown also is an optional sensing resistor 58 of low resistance R, e.g. 10 ohms, for sensing the current to control the coil charging and discharging for multiple firing of the ignition coil Ti. Otherwise one, or both of the engine speed and load, and/or other parameters, may be used to define the shortened single spark time Tspo and the total firing time Td, designated Tcold-start and Tidle in the two cases of FIGS. 11a and 11b.

Preferably, the firing control is done with a micro-controller (MCU 59 shown) which gets ignition firing signals and other information, as required, e.g. manifold absolute pressure (MAP), water temperature Twater, etc., and then decides whether to produce one ignition coil charging and firing or multiple firings per spark. For example, during engine cold-start, the MCU may be instructed to fire five pulses for a spark duration of many milli-seconds (msecs) as shown in FIG. 11a, for a cold-start period of up to one minute, where the vertical axis represents the spark current Ispark, whose peak is preferably in the 300 to 600 milliamp (ma) range. Note that as a result of the high charging voltage Vc and low coil primary inductance of approximately 400 micro-Henry (uH) in the case of FIG. 10 (although it can range from 200 to 800 uH), the charge time is very short, approximately 300 usecs, so that the time required to recharge the coil from a current corresponding to Iset (FIG. 11a) to Ipk, designated Tcho, is of the order of 100 usecs, while the total spark duration of one spark Tspark (FIG. 11a) is the order of 1000 usecs, somewhat higher at idle speeds (low air flow) and lower at high engine speeds (high engine flow). This easily provides an approximately 80% duty cycle, where duty cycle is defined as the total time of the spark Tspark1 divided by Tspark1 plus the sum of the total times Tcho (recharging times), designated Tch1. For the case of FIG. 11a, Tspark1 is the sum of five spark discharge times, four short and one long, and Tch1 is the sum of four spark off times Tcho.

The firing information is transmitted to the various switches Si in the proper firing order, shown here by means of a separate MCU 60 in case it is at a different location from MCU 59, although MCU 59 and MCU 60 preferably comprise one MCU. Note that as per FIG. 11b five spark pulses are designated for idling (to improve combustion stability), for a total idle time Tidle which can be of the range of 5 msecs.

At certain speed and loads, if required, a lower energy, single spark can be used which is controlled by the MCU which can simply shorten the single firing charge time from, say, typically 300 usecs to 200 usecs to reduce heating of the plug end since high spark energy may not be required at high load operation (where a stoichiometric mixture is used).

FIG. 12 is an approximately to scale or larger, depending on required energy, top view drawing of a preferred embodiment of a compact, open E-type ignition coil with two magnets 42e and 42f at the open ends, and using silicon iron laminations, the outer legs 41a being larger stacks of thin strips of laminations separate from a center “T” leg 40a smaller stack of laminations. Like numerals represent like parts with respect to FIG. 10.

In this preferred embodiment, the outer legs 41a of the laminations are separated by small gaps 49 from the center “T” leg, and they can be encased and electrically floating to minize the required separation from the secondary winding in the secondary bobbin 43, which is preferably of the segmented type of FIG. 10. This design is an improvement over the standard open E-type core disclosed in my patent '130 in that, besides the magnets, the two gaps 49 will store additional magnetic energy to provide a higher energy density. Preferably, 55 to 75 turns of primary wire 46 are used, preferably bifilar winded (pairs of wires), and more ideally 60 to 70 turns for a primary inductance Lp of 300 to 600 uH. In this case, the primary wire is on the inside, and the inside “T” lamination 40a may be grounded. Note that stack of the outer lamination legs 41a can be two to three times higher than the center leg stack 40a, and their width is narrowed accordingly for a more compact design with less waste of laminations in the lamination manufacturing process.

For an open E-type ignition coil with two magnets at the end of the laminations, either as already disclosed in my U.S. patent application '057, or that is disclosed in FIG. 12, a design may be prefer which has a peak secondary current of 300 ma to 400 ma, which is covered by my published PCT application '057, but not given by way of example. In this example, is given a range of parameters covering the case of 300 ma to 400 ma of peak secondary current Is, and a peak primary current Ip of approximately 20 to 25 amps.

For assumed coil dimensions of 2.5″, 1.5″, and 1.2″, a bobbin of length of 1.4″ is assumed with ten bays and with two biasing magnets at the open end, approximately 70 turns of primary winding (Np=70) of bifilar magnet wire of 26 AWG (equivalent to 23 AWG), and secondary turns Ns of 4,100 (turns ratio Ns/Np of approximately 58) of 36 AWG to 38 AWG. The coil has inductance of approximately 630 uH (micro-Henry), i.e. 500 uH to 800 uH. The coil energy is typically 120 mJ to 150 mJ. The core area is assumed to be approximately 0.7 square cms. The biasing magnet dimensions are approximately 0.38″, 0.35″, 0.23″, there being very little leakage magnetic flux since the magnet takes up the space between the center lamination and the outer laminations, e.g. magnet takes up 0.38″ of 0.39″ space. Such a coil was built to these dimensions (within 10%) with energy 140 mJ and Is of 380 ma. The advantage of such a coil is that it has a less than ½ the secondary turns, and an energy density of 4 to 5 times of a conventional coil, as well as 1/5 times the rise time (5 usecs) and 1/5 times the charge time (400 usec to 500 usec). Since the spark current can be 300 ma, it can be in the glow-discharge mode for the major period of time, i.e. below 200 ma (2/3 the time), which has many advantages, including relatively low erosion.

In summary, the present invention of improved ignition-flow-coupling accomplished through improved squish flow control by use of flow channels to better guide the squish flow at the spark plug gap, and the use of improved compact high energy, high efficiency pencil type ignition coils, makes for an easier and lower cost method to more universally apply the beneficial principles of ignition flow coupling to all types of spark ignition engines, for more complete and faster combustion of the air-fuel mix, especially of ultra-lean mixtures. It should be noted that there are many ways to create channels in the squish land region, including adding a thin plate on the cylinder head or piston top with grooves or slots cut into it, which can be of advantageous material, i.e. palladium coated steel or other base material to help catalyze the combustion reactions.

To summarize, the inventions disclosed herein, taken in part or as a whole, represent an improvement of the 42 volt based, low inductance, high ignition flow-coupling, coil-per-plug ignition system previously developed and patented by myself for application to lean burn and high EGR engines, to simplify the design and packaging of parts and their inter-connection, as well as to improve the design and application of the coils and their operation, especially of pencil coils, which will broaden their possible application, including for retrofitting with older distributor ignition systems, including V-8 engines.

What is claimed is:

1. An internal combustion engine for igniting, combusting, and expanding an air-fuel mixture and producing work by means of a movable member within a combustion chamber, and for also producing an ignition-flow-coupling action to direct the mixture just prior to ignition in one or more squish zones with rapid motion of the mixture at the ignition site,
said engine being constructed and arranged so that the mixture motion is improved and intensified by provision of one or more essentially radially inwards disposed narrow channels at a chamber surface and/or movable member surface and terminating near the squish land regions for directing the squish flow to the spark plug tip so that the flow moves in a highly directed, organized, channeled way, versus directing flow in a diffused way at the edge of the squish zone,
to improve the coupling of the flow to the spark to move and spread it with greater intensity and control than might otherwise take place without the use of the channeled flow.

2. An engine with channeled flow as defined in claim 1 and with intake and exhaust valve openings in a chamber wall, wherein part or most of the combustion chamber is under the exhaust valve, the channels being disposed to move the squish induced flow, with intensity, through the one or more spark gaps, and more towards the exhaust valve for improved combustion.

3. An engine with channeled flow as defined in claim 1 wherein the engine is a 2-valve, dual-squish-flow, dual ignition engine with high spark energy, wherein the channels are placed in the high squish zones focusing and terminating in the region of the high energy ignition sparks, wherein the channels can be located in the cylinder head, or on the piston, or on a separate plate held between the cylinder head and cylinder.

4. An engine with channeled flow as defined in claim 1 wherein the engine is a 2-valve, dual ignition engine with high spark energy with channels placed in the high squish zones of dual squish lands with the most rapid air-flow occurring at the spark plug sites to couple to the spark and move it rapidly in the combustion chamber.

5. An engine with channeled flow as defined in claim 1 wherein the movable member is a piston which moves up near Top Center, the channeled air-fuel mixture flow is directed through the spark gap and radially inwards, constructed and arranged so that upon ignition, which occurs near the time of maximum squish induced flow, the very high energy, flow-coupling type of spark is directed inwards and towards the hotter regions of the combustion chamber (exhaust valve region) and spread to create a more distributed and higher energy spark discharge to substantially improve ignition and early flame propagation, and the air turbulence is increased due to the colliding squisb flows to further speed up the burn, thus enabling the turbulence to be further increased by the channeled flows which have better penetrating capabilities, resulting in a faster and more complete burn of the preferred ultra-lean mixtures.

6. An engine ignition system of a high energy density cylindrical pencil coil with at least one open end, at least one end of which includes two large essentially rectangular biasing magnets spanning the center magnetic core and the outer magnetic core, the primary winding made up of a two layer winding of 50 to 100 turns Np, and the secondary winding Ns which is in the form of axially segmented windings, with turns ratio Nt(Nt=Ns/Np) between 50 and 70 for 36 kV to 45 kV peak output voltage, and having a primary inductance Lp between 0.2 and 1.0 milliHenry (mH).

7. The ignition system of claim 6 with Lp between 400 mircroHenry (uH) and 800 uH for high energy high current application of stored energy between 80 and 160 mJ, having primary Np wire turns, single or bifilar, of 22 to 26 AWG (American Wire Gauge) for the length of about 2.5″ and approximately 1.0″ diameter, excluding any high voltage tower that may be required.

8. The ignition system of claim 6 wherein there are two open ends have one pair of magnets each, for a total of four essentially rectangular inexpensive biasing magnets, partially spanning the center magnetic core and the outer magnetic core, so that the biasing magnets at each end cover less than ½ the cross-section area, so that the encapsulation can flow freely during manufacture.

9. The ignition system of claim 8 wherein the primary winding is on the outside of the coil and the secondary winding is on the inside, both windings located between the inner and outer magnetic cores, the center core having a diameter of approximately 0.35″ and length of about 2.5″, the secondary bobbin having a diameter of approximately 0.75″ with 6 to 15 bays, the primary bifilar turns of Np 60 to 90 (120 to 180 wire turns) and outer diameter of 0.9″, and primary magnet wire of gauge 23 to 26 AWG, and the outer core made up of slightly less than one turn of magnetic core material of outer diameter approximately 1.0″.

10. The ignition system of claim 8 wherein the biasing magnets at each open end produce a magnetic flux of about −1 Tesla in the core laminations, so that the total magnetic bias for the four biasing magnets is close to −2 Tesla.

11. The ignition system of claim 8 wherein Np is between 70 and 100 (140 and 200 of bifilar wire), and Nt is between 50 and 60, and IGBTs ignition switches of 600 volts rating.

12. The ignition system of claim 6 wherein the supply voltage is between 24 and 60 volts and the output of the supply voltage is a capacitor which stores many times the energy required to charge the coil, wherein the dwell time of the coil is approximately 400 usecs, wherein the coil is multi-fired during low-speed engine cold-start, or at other times as needed, e.g. at idle, so that the spark firing can extended to 5 msecs or longer, to insure better engine operation.

13. The ignition system of claim 12 wherein the secondary winding contains a blocking diode so that the coil may be multi-fired, the coil fired in sequence of about 0.8 msecs ON and about 0.2 msecs OFF, where the sequence of ON and OFF are repeated many times, made possible by the fact that many times the coil energy is stored on a energy capacitor which is part of the output of the power converter.

14. The ignition system of claim 6 wherein the cylindrical coil has one open end with two biasing magnets and the other end has an end-core material spanning at least the inner and outer cores wherein the end-core is preferably made of silicon iron.

15. A coil-per-plug engine ignition system with a high energy density coil with open E-type core with two biasing magnets at an open end, using magnetic laminations in the magnetic core, wherein the outer two legs of the core may be grounded to the remainder core, or the outer two legs may be separated by a small gap, much less than the gap at the open end, from the center core comprising a “T” lamination structure.

16. A coil-per-plug engine ignition system of claim 15 for an ignition distributor to be used in conjunction with a coil-per-plug replacement, wherein the distributor spark plug wires are replaced with an electronic trigger and phasing harness for providing well-defined ignition trigger firing signal for the ECU and phasing signals for firing the ignition coils in the proper order.

17. A coil-per-plug engine ignition system of claim 15 wherein the coil secondary winding bobbin is a segmented bobbin for a preferred square core cross-section, and a form of thin slot cut in the flanges for passing the wire between bays, the slots being very narrow and oriented at a small angle θ of under 30 degrees, relative to the flanges length direction, to provide a long breakdown path between flanges across the slots.

18. A coil-per-plug engine ignition system of claim 15 including a power converter which stores many times the coil energy in a capacitor means and can charge the coil in about ½ millisecond (msec) dwell time, and at low speed can supply enough energy for several coil charging, e.g. five coil charging at 1,500 RPM, the ignition coil being able to provide the high energy spark with the capability of extending the spark duration, by multiple firing the coil with a micro-controller, enabling spark profiles of the extended duration spark for cold-start and idle conditions respectively which are low speed operation.

19. A coil-per-plug engine ignition system of claim 15 with one open end which includes two essentially rectangular biasing magnets spanning the center magnetic core and the outer magnetic core, the primary winding made up of preferably a two layer winding of 60 to 90 turns Np, and the secondary winding Ns which is in the preferred form of axially segmented windings, with typical turns ratio Nt (Nt=Ns/Np) between 50 and 70 for a preferred 36 kV to 45 kV peak output voltage, and having a primary inductance Lp between 400 and 800 microHenry (uH) and primary current Ip of 20 to 25 amps, for the present high energy high current application of stored energy between 80 and 160 mJ, of typically having primary Np wire turns, single or bifilar, of 22 to 26 AWG (American Wire Gauge) for the length of about 2.5″ and approximately 1.0″ diameter, excluding any high voltage tower that may be required.

20. A coil-per-plug engine ignition system of claim 15 with a high energy density coil with open E-type core with two biasing magnets at the open end, using magnetic laminations in the magnetic core, wherein the outer two legs are separated by a small air gap, much less than the gap at the oped end, from the center core comprising a “T” lamination structure, wherein the primary winding is wound directly onto the center “T” lamination core.
